(19) United States
(12) Patent Application Publication
(10) Pub. No.: US 2021/0092251 A1
(43) Pub. Date: Mar. 25, 2021

(54) SYSTEM AND METHOD FOR CONCURRENT CONTROL OF DOCUMENT PROCESSING OPERATIONS BY MULTIPLE DEVICES

(71) Applicant: Toshiba TEC Kabushiki Kaisha, Shinagawa-ku (JP)

(72) Inventor: Marianne KODIMER, Huntington Beach, CA (US)

(21) Appl. No.: 16/577,200

(22) Filed: Sep. 20, 2019

(51) Int. Cl. H04N 1/00

(52) U.S. Cl. CPC H04N 1/00931; H04N 1/00973; H04N 2201/0094; H04N 1/00411; H04N 1/00482

(57) ABSTRACT

A system and method for providing seamless, alternative or concurrent control of document processing devices by multiple devices includes a processor, memory, digital data interface and user interface configured to receive user input, such as setting job properties on a multifunction peripheral. A settings screen is displayed for receiving user settings for job properties, such as finishing options, duplex options or scan resolution. As a user makes selections, they are reflected on the user interface and propagated to user interfaces of one or more alternative devices. A user may commence entering settings on one device and switch seamlessly to continue entering settings at the same point on an alternative device.

### TECHNICAL FIELD

This application relates generally to printing. The application relates more particularly to seamless integration of concurrent control of document processing operations via user interfaces of multiple devices.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Document processing operations, such as printing, scanning, and faxing, are typically configured by the user via a front panel user interface on the MFP.

### BRIEF DESCRIPTION OF THE DRAWINGS

Various embodiments will become better understood with regard to the following description, appended claims and accompanying drawings wherein:

FIG. 1 is an example embodiment of a system for seamless, alternative or concurrent control of document processing devices by multiple devices;

FIG. 2 is an example embodiment of a document rendering system;

FIG. 3 is an example embodiment of a digital data device;

FIG. 4 is a flowchart of an example embodiment of a system for seamless, alternative or concurrent control of document processing devices by multiple devices;

FIG. 5 is an example embodiment of a workflow sequence;

FIG. 6 is a flow diagram of an example embodiment of a system for integration of control displays among networked devices;

FIG. 7 is an example embodiment of task handoffs between devices;

FIG. 8 is an example embodiment of a device user interface; and

FIG. 9 is an example embodiment of a device user interface for a portable data device synced with the user interface of FIG. 8.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In example embodiments detailed below, an MFP user interface handoff is made between devices to provide continuity across an MFP, smartphone, tablet computer, notebook computer or workstation. This allows users to start steps involved in commencing and setting up a document processing job on one device and shift setup to a different device at any time. By way of particular example, a user can select a document for printing on their smartphone, and start setup of the print job to their specifications. The user may, for example, select a number of copies desired while on their smartphone. As the user approaches the MFP, the user can put their smartphone aside and immediately resume their job setup on the MFP's touchscreen which reflects the settings at the state that appears on the user's smartphone.

An interface handoff provides continuity across two or more devices. This allows, for example, a user to complete a task on an MFP that was started on their smartphone, or vice versa. User interfaces, along with a position in the workflow, is shared such as via a network cloud, Wi-Fi, Bluetooth, or any other suitable means of data communication.

Because some tasks may be more easily configured from mobile or other computing devices than they are on the MFP interface, or vice versa, the option to begin on one device and complete on the other provides significant flexibility. Further, time and effort is not lost by initiating a task on one device and completing on the other if the user is interrupted and must be continued later. Alternatively, the user interface can be synced between multiple devices and control shifted among them. Applications may be synced where one executes on an MFP and the other executes on another device, such as a mobile computing device, wherein settings, workflow, position within one application is mirrored on the other. This provides continuity between working on the MFP and another computing device. User preferences, such as settings, address book, and other personal data can be maintained locally and transferred or “synced’ as needed on an MFP.

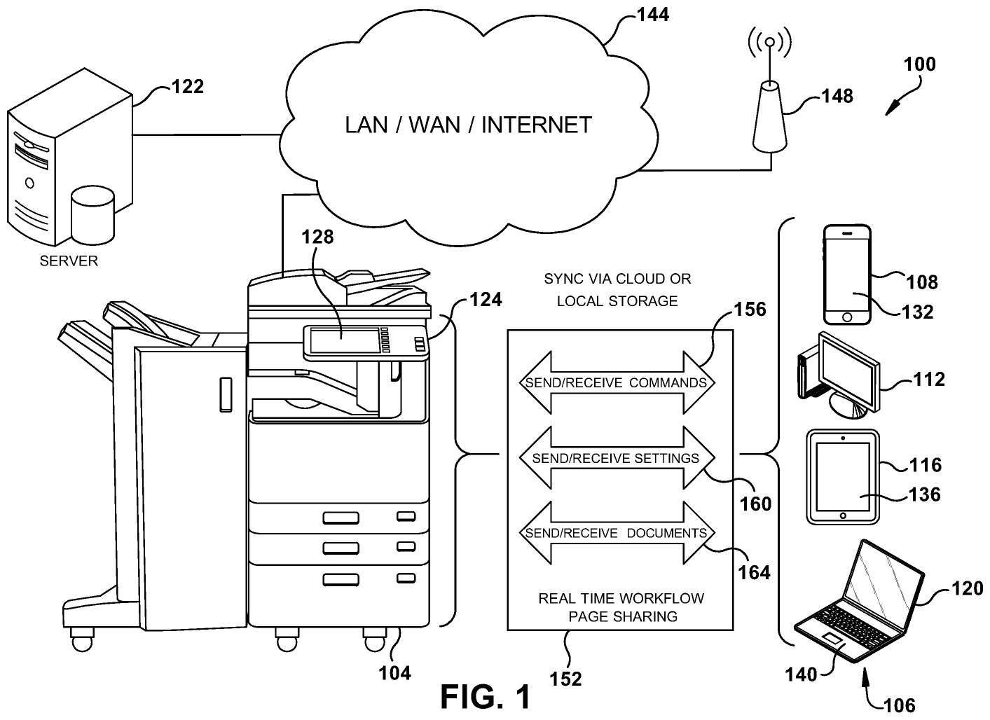

In accordance with the subject application, FIG. 1 illustrates an example embodiment of a system 100 for seamless, alternative or concurrent control of document processing devices by multiple devices. Included are one or more MFPs, such as MFP 104. Also included are additional digital data devices 106 such as smartphone 108, workstation 112, tablet computer 116 and notebook computer 120. Also included is one or more networked servers, such as cloud server 122.

MFP 104 includes a user interface 124 including a touchscreen display 128. Digital data devices 106 include respective user interfaces, such as touchscreens 132 of smartphone 108, touchscreen 136 of tablet 116 and keyboard 140 of notebook computer 120. Digital computing devices of FIG. 1 are suitably in data communication, wired or wirelessly, with network cloud 144, suitably comprised of a local area network (LAN), wide area network (WAN), which may comprise the Internet, or any suitable combination thereof. Wireless communication is suitably via Wi-Fi hotspot 148. As will be detailed further below, a distributed user interface for MFP 104 is provided among digital data devices 106, provided by workflow page sharing 152. Workflow page sharing 152 includes sharing of send/receive commands 156, send/receive settings 160 and send/receive documents 164. Such syncing or sharing is suitably accomplished via network cloud 144 or via local storage, and may be facilitated by cloud server 122.

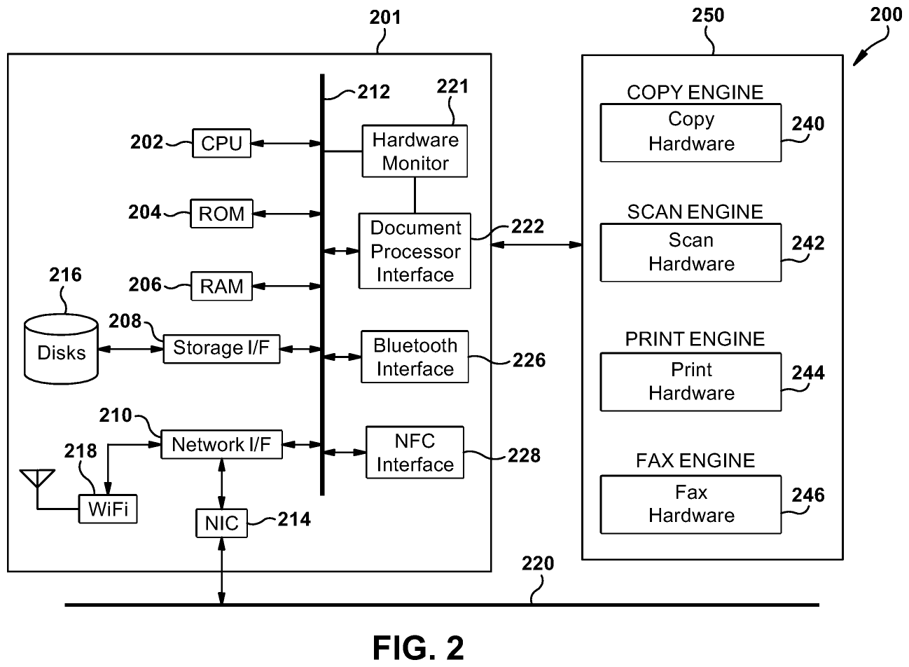

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication with document processor interface 222, BLUETOOTH interface 226 and NFC interface 228 via data path 212.

Processor 202 can also be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrated example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

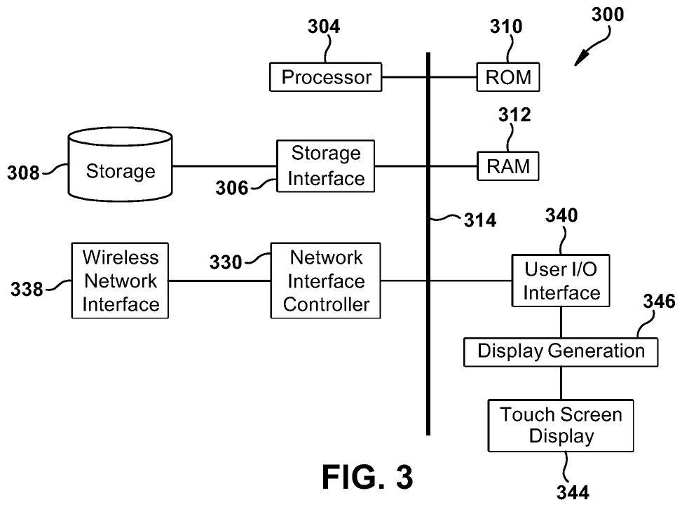

Turning now to FIG. 3, illustrated is an example of a digital device system 300 suitably comprising digital devices 106 or cloud server 122 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide arear network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

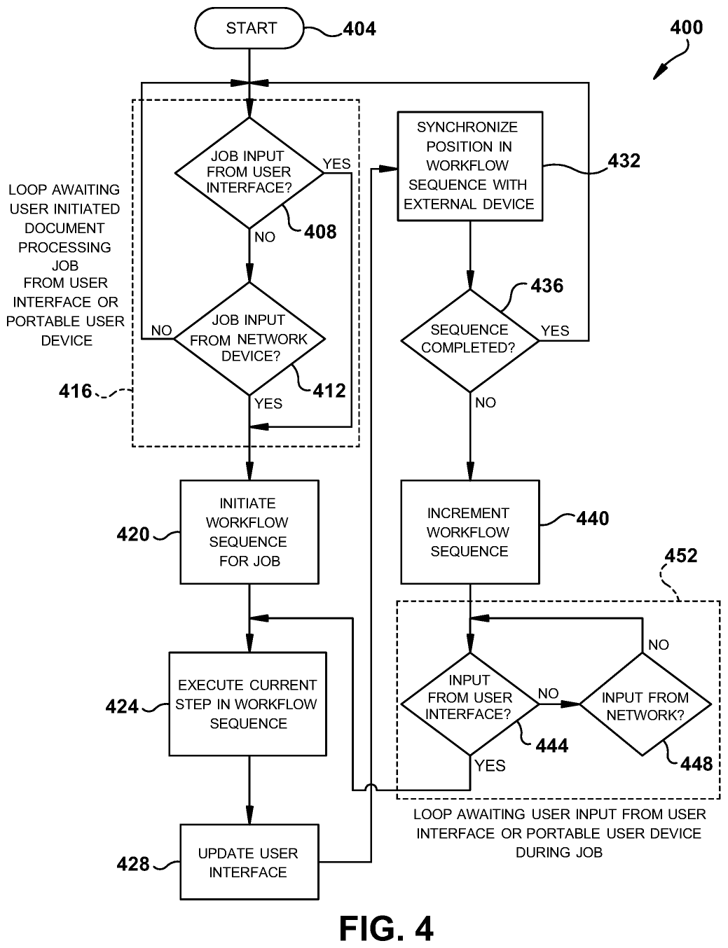

FIG. 4 illustrates a flowchart 400 of an example embodiment of a system for seamless, alternative or concurrent control of document processing devices by multiple devices. The system commences at block 404 and proceeds to block 408 wherein a determination is made whether there is document processing job input from a user interface of device currently in use by an associated user. If not, a determination is made at block 412 as to whether such input is provided from a networked device. If not, the process returns to block 408. Thus, the system remains in loop 416 until such time as job input is received locally or via a networked device.

Once job input is received, progress is made to block 420 wherein a job workflow sequence is initiated. As will be detailed below, a job workflow sequence may include receiving user settings, such as numbers of copies, page finishing options, collation, hole punching, stapling, paper type, color/black-and-white, and the like. A user makes one or more selection in a sequence, such as first selecting a stapling option, and then selecting a collation option. Each action suitably comprises a step in a workflow, followed by job execution, such as printing or faxing.

Once a workflow sequence has been initiated at block 420, a current workflow step is executed at block 424, and the user's device user interfaces is updated to reflect the user's selection at block 428. Next, the user's selection is synchronized with one or more external devices at block 432 such that their respective user interfaces will reflect the current user interface on the user's device. A test is made at block 436 as to whether the workflow sequence has been completed, such as by initiation of a document printout. If completed, the process returns to block 408. If not, the workflow sequence is incremented at block 440. A test is made at block 444 to determine if any input has been received from the current user device interface. If not, a test is made at block 448 to determine whether input is received from a networked device. If not, the process returns to block 444. Thus, the system is maintained in look 452 until such time as user input is received at any synced device. Once input is received, the process returns to block 432.

It will be seen from the flowchart of FIG. 4 that a user can move seamlessly between user interfaces of various devices and control MFP operation from any or all of them.

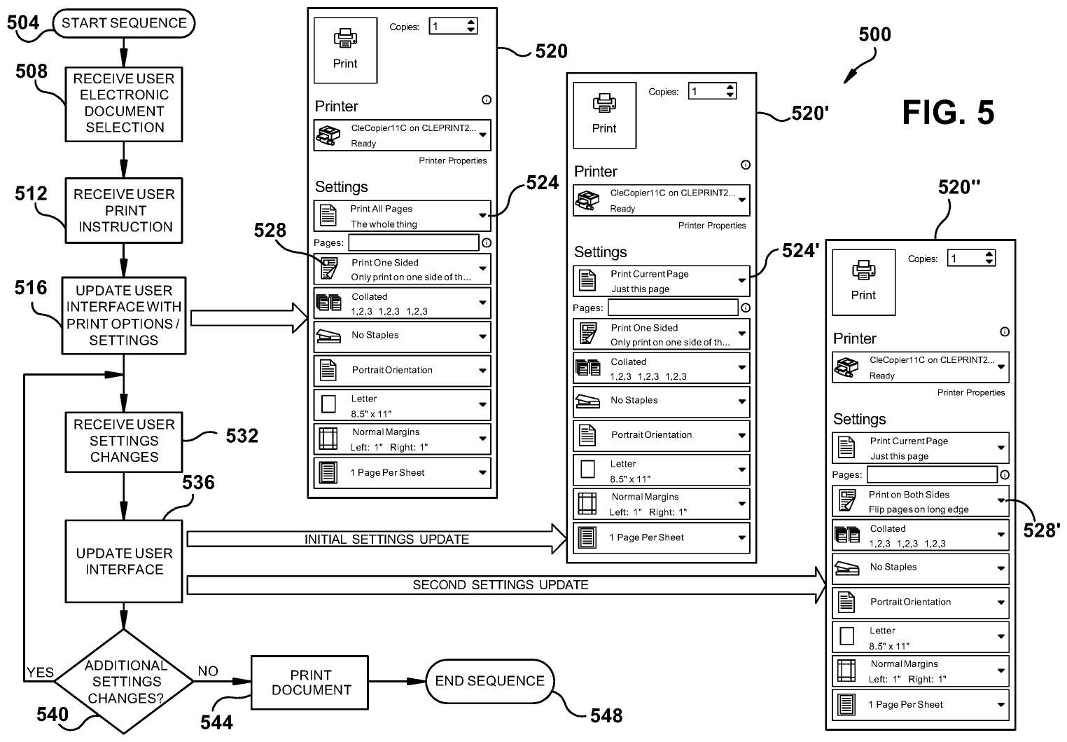

FIG. 5 is an example embodiment of a workflow sequence 500. The sequence commences at block 504 and a user selects one or more documents for scanning, printing, e-mailing or faxing at block 508. A user instruction, such as a print instruction, is received at block 512, and a user interface display corresponding to the selection is generated at block 516. Example user interface 520 includes selectable print settings, such as page selection 524 and duplex selection 528. A user supplies a selection corresponding to the displayed settings options at block 532. The user interface is updated to reflect the user's selection at block 536. In the illustrated example, updated interface 520′ now reflects a user's page selection to print only the current page at block 524′. This selection is communicated to one or more networked devices as detailed above. A test is made at block 540 whether additional user input is received. If so, the process returns to block 532. In the illustrated example, the user then selects duplex printing, which selection appears on user interface 520″ at duplex selection 528′. When no additional settings are changed at block 540, the document is printed at block 544 and the workflow sequence ends at block 548.

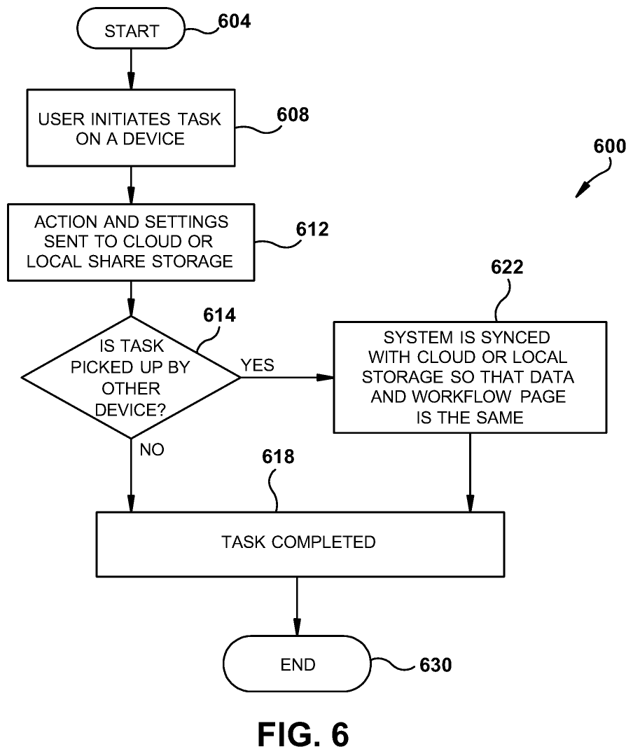

FIG. 6 is a flow diagram 600 for integration of control displays among networked devices. The process commences at block 604 and a user initiates a document processing task at block 608. User selections are shared via a network cloud or local storage at block 612. A test is made at block 614 to determine whether the task has been picked up by another device, such as when a user transfers interaction to an alternative device. If not, the task is completed at block 618. If so, the system is synced with cloud or local storage at block 622 before proceeding to block 618. The system suitably ends at block 630 once the task has been completed.

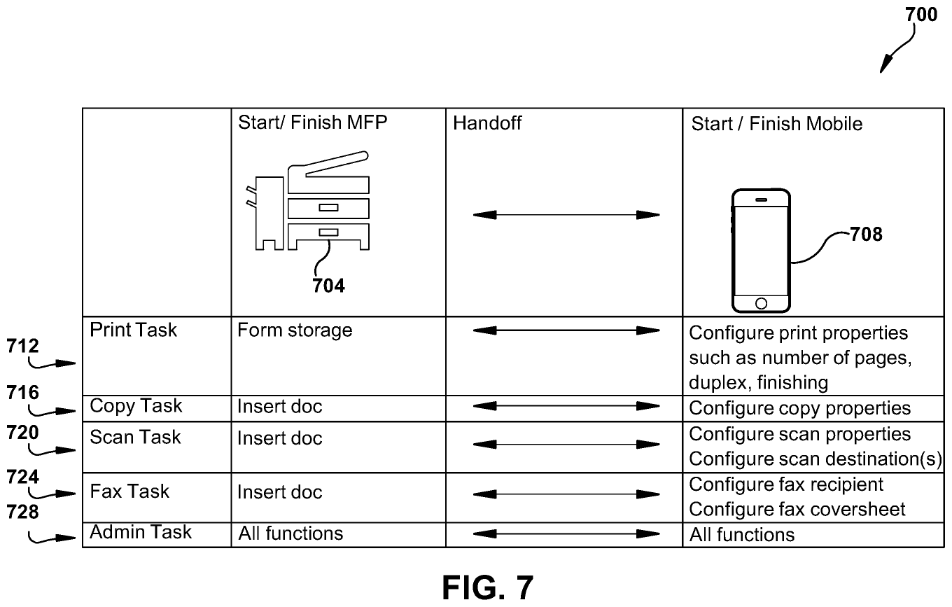

FIG. 7 is an example embodiment of task handoffs 700 between MFP 704 and smartphone 708. In the illustrated example, a print task, such as configuration of print properties, is handed between MFP 704 and smartphone 708 as indicated at 712. Similarly, a copy task is handed off between devices at 716, a scan task handoff is at 720, a fax task handoff is at 724 and an administrative task, such as device setup, handoff is at 728.

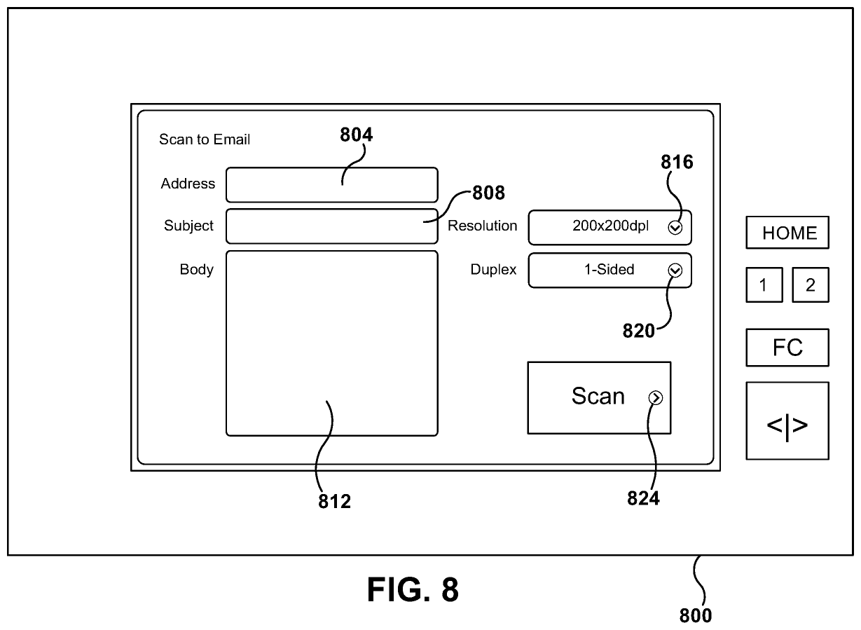

FIG. 8 is an example embodiment of a user interface 800, such as may appear on an MFP touchscreen interface or some other digital device. In the illustrated example, scan to email has been previously selected resulting in the illustrated interface. User input, such as address information at 804, message subject line at 808 and message body at 812 is suitably input. When such input is made, it is reflected on corresponding user interfaces of other devices as detailed above. Setting may also be specified, such as scan resolution at 816 and duplex options at 820. A workflow is suitably ended when scan button 824 is selected to complete the operation in accordance with the user's input. Any or all actions may be done on any synced device.

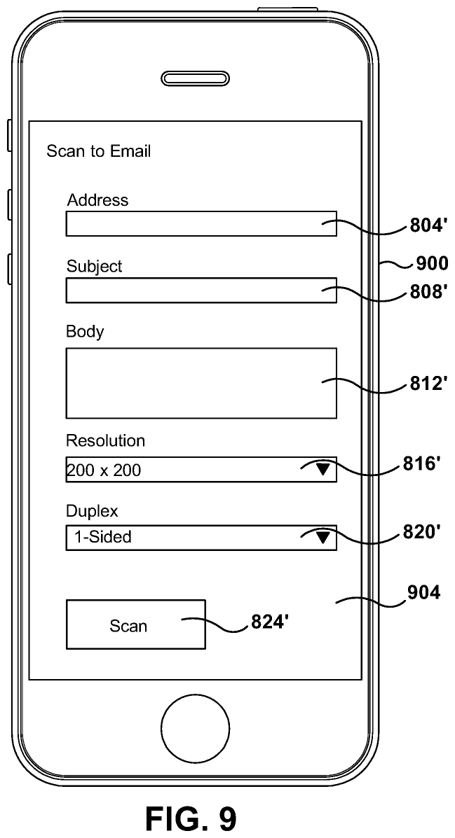

FIG. 9 illustrates in example embodiment of smartphone 900 including touchscreen user interface 904, which user interfaces corresponds with the interface of FIG. 8. In the illustrated example, address input is synced at 804′, subject input is synced at 808′, message body input synced at 812′, resolution is synced at 816′ and duplex section synced at 820. In the examples of FIGS. 8 and 9, the same information and selection capabilities are mirrored between devices, albeit with a layout more appropriate for each respective device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
a document processor configured for scanning or printing;
a memory;
a user interface; and
a data interface,
wherein the processor is configured to receive a document processing instruction for the document processor from an associated user via the user interface or the data interface,
wherein the memory is configured to store a workflow sequence corresponding to the received document processing instruction,
wherein the processor is further configured to sequentially execute steps in accordance with the stored workflow sequence,
wherein the processor is further configured to synchronize each step in the workflow sequence with an external data device via the data interface, and
wherein the processor is further configured to increment, until completion of the workflow sequence, steps in the workflow sequence in accordance with user input received via the user interface or the data interface.

2. The system of claim 1 wherein the processor is further configured to update a display on the user interface in accordance with each executed step in the workflow sequence.

3. The system of claim 2 wherein the processor is further configured to initiate a remote display update on the external data device corresponding each updated display on the user interface.

4. The system of claim 3 wherein the document processing instruction is comprised of a print, scan or fax instruction.

5. The system of claim 4 wherein the user input is comprised of one or more page format settings.

6. The system of claim 5 wherein the page format settings are comprised of print properties, scan properties or fax properties.

7. The system of claim 5 wherein a portion of the user input is received via the user interface and a portion of the user input is received via the data interface.

8. A method comprising:
receiving a document processing instruction for a document processor from an associated user via a user interface or a data interface;
storing a job workflow sequence corresponding to a received document processing instruction;
sequentially executing steps of the stored workflow sequence;
synchronizing each step in the workflow sequence with an external data device via the data interface; and
incrementing, until completion of the workflow sequence, steps in the workflow sequence in accordance with user input received via the user interface or the data interface.

9. The method of claim 8 further comprising updating a display on the user interface in accordance with each executed step in the workflow sequence.

10. The method of claim 9 further comprising initiating a remote display update on the external data device corresponding each updated display on the user interface.

11. The method of claim 10 wherein the document processing instruction is comprised of a print, scan or fax instruction.

12. The method of claim 11 further comprising receiving the user input comprised of one or more page format settings.

13. The method of claim 12 wherein the page format settings are comprised of print properties, scan properties or fax properties.

14. The method of claim 12 further comprising receiving a portion of the user input via the user interface and a portion of the user input via the data interface.

15. A system comprising:
a processor;
a memory;
a wireless data interface; and
a user interface configured to display page settings associated with a document processing job on an associated multifunction peripheral in accordance with document settings received via the user interface or the wireless data interface,
wherein the processor is configured to send and receive steps in a document processing job workflow sequence associated with the document processing job on the associated multifunction peripheral, and
wherein the processor is further configured to generate an updated display of the page settings in accordance with each step in the job workflow.

16. The system of claim 15 wherein the steps comprise user specified job settings for the document processing job.

17. The system of claim 16 wherein the job settings include print settings, scan settings or fax settings.

18. The system of claim 17 wherein the print settings include document finishing options.

19. The system of claim 18 wherein the document finishing options include a duplex selection, a copy count selection, a stapling selection or a hole punch selection.

20. The system of claim 19 wherein the user interface is comprised of a touchscreen.
